(19) United States
(12) Patent Application Publication
(10) Pub. No.: US 2007/0028252 A1
(43) Pub. Date: Feb. 1, 2007

(54) Optical recording and playback apparatus

(75) Inventors: Keun Ho Lee, Seoul (KR); Jeung Rak Lee, Suwon-si (KR); Yong Hoon Lee, Suwon-si (KR); Hong Kyun Yim, Suwon-si (KR); Jae Yong Eum, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/435,900

(22) Filed: May 18, 2006

(30) Foreign Application Priority Data
Jul. 26, 2005 (KR) 2005-67849

(51) Int. Cl. G11B 17/04

(52) U.S. Cl. 720/610

(57) ABSTRACT

An optical recording and/or playback apparatus in which a disc is prevented from being ejected from the optical recording and playback apparatus during operation of the optical recording and playback apparatus. The optical recording and playback apparatus includes a main body having an entrance, a deck mounted in the main body and having a spindle motor and an optical pickup unit, a tray mounted at the main body such that the tray is inserted into or ejected from the main body through the entrance, a loading unit to insert or eject the tray into or from the main body, and a safety door mounted at the entrance to close the entrance after the tray is inserted into the main body, the safety door being opened and closed according to the operation of the loading unit.

### CROSS-REFERENCE TO RELATED APPLICATIONS

This application claims the benefit of Korean Application No. 2005-67849, filed Jul. 26, 2005, in the Korean Intellectual Property Office, the disclosure of which is incorporated herein by reference.

### BACKGROUND OF THE INVENTION

1. Field of the Invention

An aspect of the present invention relates to an optical recording and playback apparatus, and, more particularly, to an optical recording and playback apparatus including a safety door to prevent a disc from being ejected from the optical recording and playback apparatus during operation of the optical recording and playback apparatus.

2. Description of the Related Art

An optical recording and playback apparatus is an apparatus that is capable of reading information, such as audio, video, and data, from a disc and recording the information to the disc. The optical recording and playback apparatus is generally used in computers or digital electric home appliances. An example of the optical recording and playback apparatus is disclosed in Korean Unexamined Patent Publication No. 2004-82214.

The optical recording and playback apparatus includes a tray to insert a recording medium, such as a disc, into a main body such that the disc is located on a drive unit. A disc location part, on which the disc is located, is disposed at the upper surface of the tray. The tray is inserted into and/or ejected from the main body through an entrance formed at the front surface of the main body in a sliding fashion while the disc is located on the tray. When information is read from the disc or information is recorded to the disc after the disc is inserted into the main body, the disc is rotated at high speed by a drive unit.

When an external impact is applied to the optical recording and playback apparatus during an operation of the optical recording and playback apparatus, however, the disc, which is being rotated at high speed, may be separated from the drive unit and then ejected from the optical recording and playback apparatus through the gap between the entrance of the main body and the tray, by which users may be injured. Since recent optical recording and playback apparatuses are capable of operating at a 52×X speed recording operation, in which the disc is rotated at 10,000 rpm or higher, a possibility of injury is increased.

For this reason, computers or electric home appliances adopting the optical recording and playback apparatus have a front door mounted in front of the entrance of the optical recording and playback apparatus to prevent the disc from being ejected from the optical recording and playback apparatus. However, the front door is configured such that the front door is pushed by the tray and, thus, opened when the tray of the optical recording and playback apparatus is ejected from the optical recording and playback apparatus, and is closed by the spring force of a spring when the tray is inserted into the optical recording and playback apparatus. Consequently, relatively easily opening the front door from the outside of the front door by a user is possible, and, therefore, a possibility of injury is not completely eliminated.

### SUMMARY OF THE INVENTION

Therefore, an aspect of the invention provides an optical recording and playback apparatus constructed such that a disc is prevented from being ejected from the optical recording and playback apparatus during operation of the optical recording and playback apparatus.

In accordance with one aspect, the present invention provides an optical recording and playback apparatus comprising: a main body having an entrance; a deck mounted in the main body and having a spindle motor and an optical pickup unit; a tray mounted at the main body such that the tray is inserted into or ejected from the main body through the entrance; a loading unit to insert or eject the tray into or from the main body; and a safety door mounted at the entrance to close the entrance after the tray is inserted into the main body, the safety door being opened and closed according to the operation of the loading unit.

The tray has a first rack gear extending a predetermined length in the direction in which the tray is inserted or ejected, and the loading unit includes a loading motor, a pinion gear engaged with the first rack gear and rotatable by the loading motor, a cam having a second rack gear engaged with the pinion gear, the cam being moved forward and backward according to the operation of the pinion gear to raise and lower the deck, and an actuating lever to open and close the safety door according to the forward and backward movement of the cam.

The safety door is mounted at the entrance of the main body such that the safety door is moved upward and downward.

The actuating lever includes a support shaft rotatably mounted in the main body, a first extension part extending from one end of the support shaft such that the first extension part can be pushed by the cam and thus turned, and a second extension part extending from the other end of the support shaft toward the inside surface of the safety door and coupled with the safety door such that the second extension part can be turned.

In accordance with another aspect, the present invention provides an optical recording and playback apparatus comprising: a main body having an entrance; a tray mounted at the main body such that the tray is inserted into or ejected from the main body through the entrance; a loading unit to insert or eject the tray into or from the main body; a safety door mounted at the entrance to close the entrance after the tray is inserted into the main body; and a drive unit to open and close the safety door.

The drive unit includes a movable member having an inclined slot to raise and lower the safety door to open and close the safety door, and a solenoid drive part to drive the movable member forward and backward.

The optical recording and playback apparatus further comprises: a sensing unit to sense the insertion or the ejection of the tray to control the operation of the drive unit.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view illustrating the interior structure of an optical recording and/or playback apparatus according to a first embodiment of the present invention;

FIG. 2 is a perspective view illustrating the structure of the optical recording and/or playback apparatus according to the first embodiment of the present invention when a safety door is opened;

FIG. 3 is a perspective view illustrating the structure of the optical recording and/or playback apparatus according to the first embodiment of the present invention when the safety door is closed;

FIG. 4 is an exploded perspective view illustrating the structure of a cam, an actuating lever, and the safety door of the optical recording and playback apparatus according to the first embodiment of the present invention;

FIG. 5 is a perspective view illustrating the structure of an optical recording and/or playback apparatus according to a second embodiment of the present invention when a safety door is opened; and

FIG. 6 is a perspective view illustrating the structure of the optical recording and playback apparatus according to the second embodiment of the present invention when the safety door is closed.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

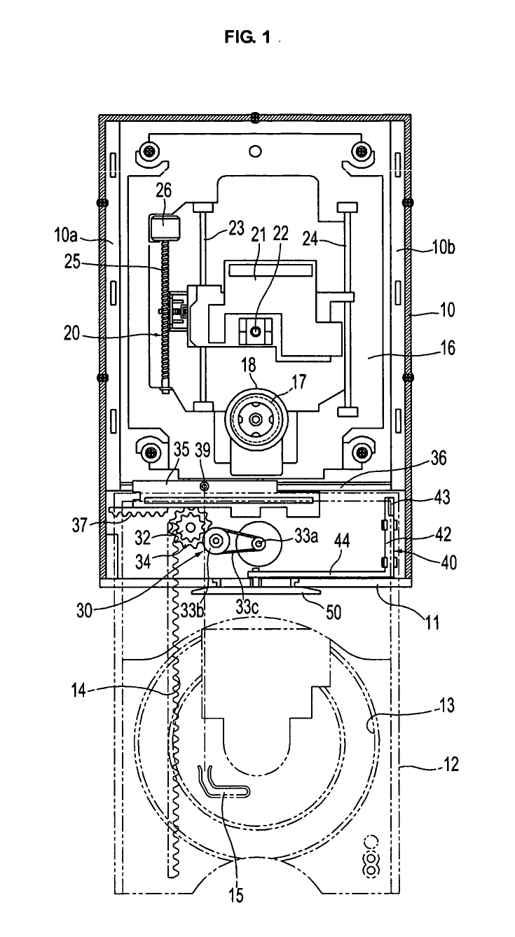

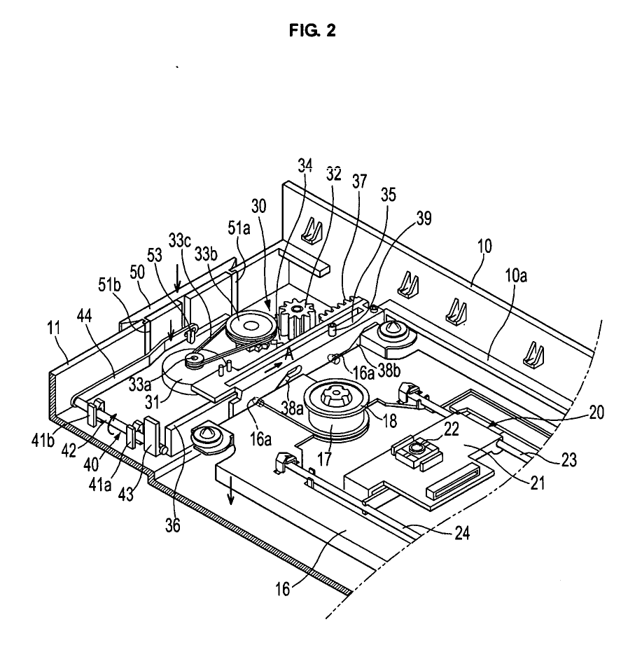

Referring to FIGS. 1 to 4, an optical recording and/or playback apparatus, according to a first embodiment of the present invention, is illustrated. As shown in FIGS. 1 and 2, the optical recording and playback apparatus includes a main body 10, having an entrance 11 formed at the front surface thereof, and a tray 12 configured such that the tray 12 may be inserted into and/or ejected from the main body 10 through the entrance 11 of the main body 10. The optical recording and playback apparatus further includes a loading unit 30 to insert or eject the tray 12 into or from the main body 10, a deck 16 mounted in the main body such that the deck 16 may be moved upward and downward, a spindle motor 17 and an optical pickup unit 20 mounted at the deck 16, and a safety door 50 to close the entrance 11 after the tray 12 is inserted into the main body 12.

The tray 12 has a disc location part 13 formed at the upper surface thereof such that a disc (not shown) may be located on the disc location part 13. Also, the tray 12 has opposite ends, which are supported by guide rails 10a and 10b mounted at opposite sides of the main body 10 such that the tray 12 may be inserted into or ejected from the main body 10 in a sliding fashion by sliding along the guide rails 10a and 10b. A first rack gear 14, which extends a predetermined length in the direction in which the tray 12 is inserted or ejected from the main body 10, is disposed at the lower surface of the tray 12 such that the tray 12 may be inserted or ejected.

The deck 16 is shaped like a flat board and is moved upward and downward by the loading unit 30, which will be described below. The spindle motor 17 is mounted at the upper surface of the deck 16 to rotate the disc inserted by the tray 12. A turntable 18, at which the center of the disc may be located, is fixed to the shaft of the spindle motor 17. Consequently, when the deck 16 is moved upward by the operation of the loading unit 30 after the insertion of the disc by the tray 12 is completed, the disc is located on the turntable 18 of the spindle motor 17.

The optical pickup unit 20 includes a support plate to be moved forward or backward in the radial direction of the turntable 18 (the radial direction of the disc), an optical pickup 22 mounted at the support plate to read information from the disc or record information to the disc, guide rails 23 and 24 mounted at the deck 16 to support the support plate 21 such that the support plate 21 may be moved forward or backward, a transferring screw 25 to transfer the support plate 21, and a transferring motor to rotate the transferring screw 25. Consequently, the optical pickup 22 mounted at the support plate 21 is moved forward and backward in the radial direction of the disc to read information from the disc or record information to the disc.

The loading unit 30 includes a loading motor 31 and a pinion gear 32 configured to be rotated by the loading motor 31. The pinion gear 32 is connected to the loading motor 31 such that the pinion gear 32 may be decelerated by pulleys 33a and 33b, a connection belt 33c, and an intermediate gear 34. Also, the pinion gear 32 is engaged with the first rack gear 14, which is disposed at the lower surface of the tray 12. Consequently, when the loading motor 31 is rotated, the pinion gear 32 is rotated, by which the insertion or the ejection of the tray 12 is accomplished.

The loading unit 30 further includes a cam 35 to raise and lower the deck 16, at which the spindle motor 17 and the optical pickup unit 20 are mounted, and an actuating lever 40 to open and close the safety door 50 at the entrance 11 of the main body 10 according to the operation of the cam 35.

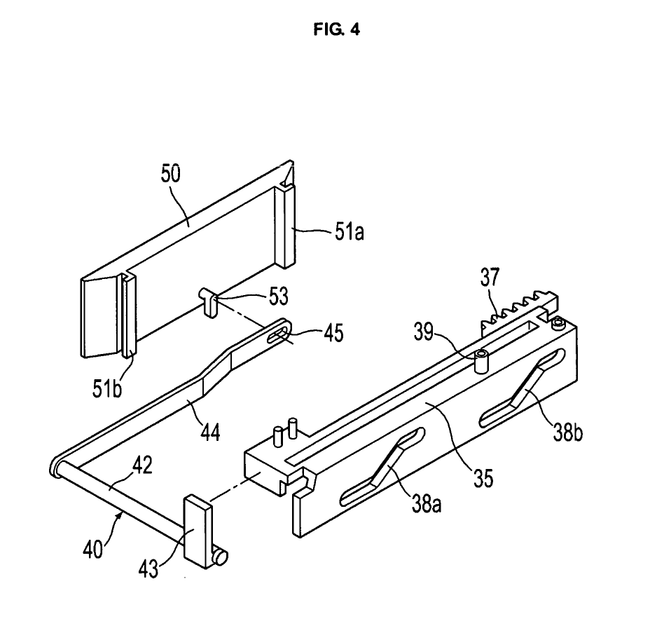

As shown in FIGS. 1 and 2, the cam 35 is mounted in the main body 10 such that the cam 35 may be moved forward and backward in the direction intersecting the direction in which the tray is inserted or ejected. The cam 35 is supported by a rail 36 disposed at the bottom surface of the main body 10 such that the cam 35 may be moved forward and backward. A second rack gear 37, which is engaged with the pinion gear 32 after the tray 12 is inserted, is disposed at one side of the cam 35. As shown in FIGS. 2 and 4, the cam 35 further include inclined slots 38a and 38b, by which the deck 16 is moved upward and downward when the cam 35 is moved forward and backward in the lateral direction. Protrusions 16a and 16b, which are protruded from the deck 16, are inserted into the slots 38a and 38b, respectively. Consequently, when the cam 35 is moved forward and backward according to the operation of the pinion gear 32, the deck 16 is moved upward and downward. As a result, the spindle motor 17 and the optical pickup unit 20 are also moved upward and downward.

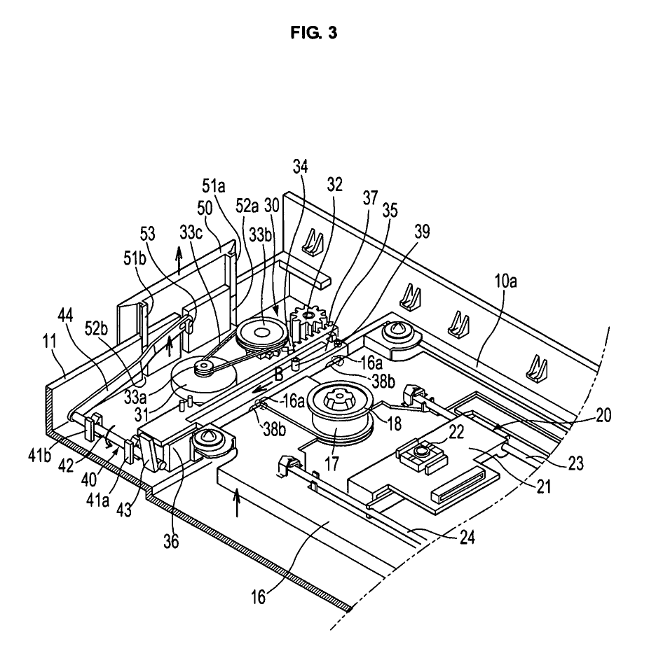

As shown in FIGS. 1 and 2, the second rack gear 37 of the cam 35 is not engaged with the pinion gear 32 when the tray 12 is ejected from the main body 10. When the tray 12 is inserted into the main body 10, however, the cam 35 is moved a predetermined distance in the lateral direction while a guide protrusion 39 formed at the upper end of the cam 35 is guided along a guide groove 15 formed at the lower surface of the tray 12. As a result, the second rack gear 37 is engaged with the pinion gear 32. When the second rack gear 37 is engaged with the pinion gear 32, the insertion of the tray 12 has already been completed, and therefore, the first rack gear 14 is disengaged from the pinion gear 32. At this time, the tray 12 is not moved, and, as shown in FIG. 3, the cam 35 is moved in a direction indicated by arrow B to raise the deck 16. Consequently, the disc is located on the turntable 18 of the spindle motor 17.

When the disc is separated from the turntable 18 of the spindle motor 17, the loading motor 31 is rotated in the reverse direction, and the above-described process is performed in reverse order. Specifically, as shown in FIG. 2, the cam 35 is moved in a direction indicated by arrow A. As a result, the deck 16 is moved downward, and therefore, the disc is separated from the turntable 18 of the spindle motor 17. Subsequently, the first rack gear 14 of the tray 12 is engaged with the pinion gear 32, and therefore, the tray 12 is ejected from the main body 10.

As shown in FIGS. 2 and 4, the actuating lever 40 includes a support shaft 42 rotatably supported by coupling members 41a and 41b at the bottom surface of the main body 10, a first extension part 43 extending from one end of the support shaft 42 such that the first extension part 43 may be pushed by the cam 35 and, thus, turned, and a second extension part 44 extending from the other end of the support shaft 42 toward the inside surface of the safety door 50 and coupled with the safety door 50 such that the second extension part 44 may be turned.

As shown in FIGS. 3 and 4, the safety door 50 has guide rails 51a and 51b disposed at opposite sides of the rear surface thereof, which are coupled with guide grooves 52a and 52b formed at the front surface of the main body 10, respectively, such that the safety door 50 is moved upward and downward a predetermined distance to open and close the entrance 11 of the main body 10. As shown in FIG. 4, a coupling protrusion 53, which protrudes from the rear surface of the safety door 50, is engaged in a coupling groove 45 formed at the second extension part 44 of the actuating lever 40. This arrangement allows the safety door 50 to be connected to the actuating lever 40.

Consequently, as shown in FIG. 3, the tray 12 is completely inserted into the main body 10, and then the cam 35 is moved in the direction indicated by the arrow B to raise the deck 16. At the same time, the cam 35 pushes the first extension part 43 of the actuating lever 40. As the first extension part 43 is pushed by the cam 35, the actuating lever 40 is rotated and the second extension part 44 is turned to push the safety door 50 upward. As a result, the entrance 11 of the main body 10 is closed by the safety door 50. Consequently, even when the disc is separated from the turntable 18 due to external impact during operation of the optical recording and playback apparatus, the disc is prevented from being ejected from the main body 10 through the entrance 11, and therefore, safe use of the optical recording and playback apparatus is accomplished.

When the operation is completed, and the disc is separated from the turntable 18 (the tray 12 is ejected from the main body 10), as shown in FIG. 2, the cam 35 is moved in the direction indicated by the arrow A and the pushing operation of the first extension part 43 of the actuating lever 40 is released. As a result, the actuating lever 40 is rotated in the reverse direction. Consequently, the safety door 50 is lowered to open the entrance 11, and, therefore, the tray 12 is ejected from the main body 10.

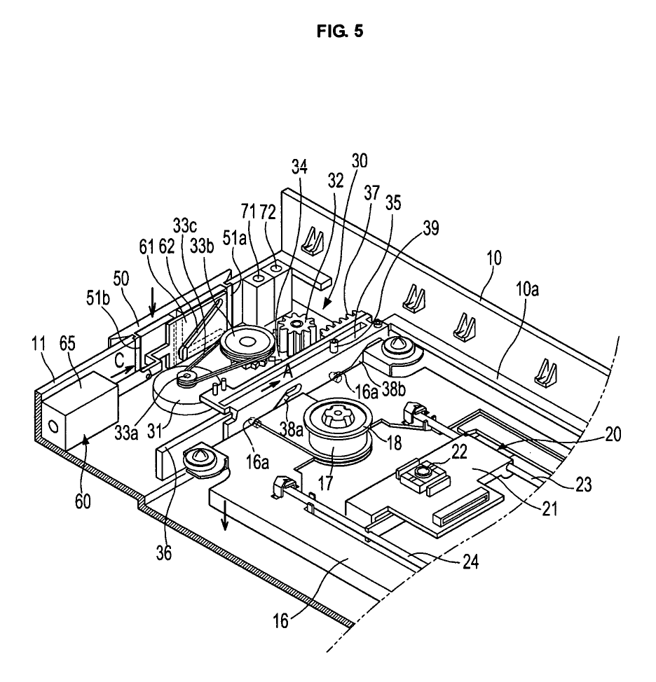

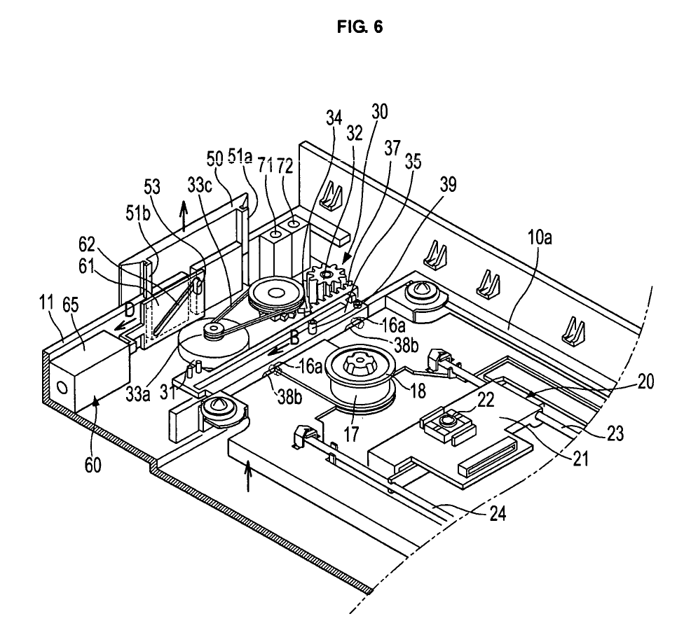

Referring to FIGS. 5 and 6, an optical recording and playback apparatus, according to a second embodiment of the present invention, is illustrated. In the second embodiment, the safety door 50 at the entrance 11 of the main body 10 is opened and closed by an additional drive unit 60, and the ejection of the tray 12 is sensed by sensors 71 and 72 to control the operation of the drive unit 60.

The drive unit 60 includes a flat board-type movable member 61 mounted at the rear of the safety door 50. The drive unit 60 includes an inclined slot 62 allowing the movable member 61 to raise and lower the safety door 50 as the movable member 61 is moved forward and backward a predetermined distance, and a solenoid drive part 65 to drive the movable member 61 forward and backward in the lateral direction. The coupling protrusion 53, which is protruded from the rear surface of the safety door 50, is inserted in a slot 62 formed at the movable member 61.

In the second embodiment, as shown in FIG. 5, when the movable member 61 is moved in the direction indicated by an arrow C according to the operation of the solenoid drive part 65, the safety door 50 is lowered to open the entrance 11 of the main body 10. When the movable member 61 is moved in the direction indicated by an arrow D according to the operation of the solenoid drive part 65, as shown in FIG. 6, on the other hand, the safety door 50 is raised to close the entrance 11 of the main body 10.

Consequently, when the sensors 71 and 72 sense that the tray 12 is completely inserted into the main body 10, the solenoid drive part 65 is operated to close the safety door 50. Specifically, the entrance 11 of the main body 10 is closed by the safety door 50 while the apparatus is operated after the tray 12 is inserted into the main body. Consequently, the disc is prevented from being ejected from the main body 10 during operation of the optical recording and playback apparatus, and, therefore, a safe use of the optical recording and playback apparatus is accomplished. When the sensors 71 and 72 sense that the ejection of the tray 12 is started, the solenoid drive part 65 is operated to open the safety door 50.

As is apparent from the above description, the safety door is raised when the tray is inserted into the main body so as to close the entrance of the main body. Consequently, the present invention prevents the disc from being ejected from the main body during the operation of the optical recording and/or playback apparatus.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical recording and/or playback apparatus, comprising:
a main body having an entrance;
a deck, mounted in the main body, having a spindle motor and an optical pickup unit;
a tray, mounted at the main body, such that the tray is inserted into or ejected from the main body through the entrance;
a loading unit to insert or eject the tray into or from the main body; and
a safety door mounted at the entrance to close the entrance after the tray is inserted into the main body, the safety door being opened and closed according to the operation of the loading unit.

2. The apparatus according to claim 1, wherein
the tray comprises a first rack gear extending a predetermined length in the direction in which the tray is inserted or ejected, and
the loading unit comprises:
a loading motor;
a pinion gear, engaged with the first rack gear, to be rotatable by the loading motor;
a cam having a second rack gear engaged with the pinion gear, the cam being moved forward and backward according to the operation of the pinion gear to raise and lower the deck; and
an actuating lever to open and close the safety door according to the forward and backward movement of the cam.

3. The apparatus according to claim 1, wherein the safety door is mounted at the entrance of the main body such that the safety door is moved upward and downward.

4. The apparatus according to claim 2, wherein the safety door is mounted at the entrance of the main body such that the safety door is moved upward and downward.

5. The apparatus according to claim 3, wherein the actuating lever comprises:
a support shaft rotatably mounted in the main body;
a first extension part extending from one end of the support shaft such that the first extension part is pushed by the cam and turned; and
a second extension part, extending from the other end of the support shaft toward the inside surface of the safety door, to be coupled with the safety door such that the second extension part is turned.

6. The apparatus according to claim 4, wherein the actuating lever comprises:
a support shaft rotatably mounted in the main body;
a first extension part extending from one end of the support shaft such that the first extension part is pushed by the cam and turned; and
a second extension part, extending from the other end of the support shaft toward the inside surface of the safety door, to be coupled with the safety door such that the second extension part is turned.

7. An optical recording and/or playback apparatus comprising:
a main body having an entrance;
a tray mounted at the main body such that the tray is inserted into or ejected from the main body through the entrance;
a loading unit to insert or eject the tray into or from the main body;
a safety door mounted at the entrance to close the entrance after the tray is inserted into the main body; and
a drive unit to open and close the safety door.

8. The apparatus according to claim 7, wherein the drive unit comprises:
a movable member having an inclined slot to raise and lower the safety door to open and close the safety door; and
a solenoid drive part to drive the movable member forward and backward.

9. The apparatus according to claim 7, further comprising: a sensing unit to sense the insertion or the ejection of the tray to control the operation of the drive unit.

10. An optical recording and/or playback apparatus, comprising:
a main body having an entrance;
a tray, mounted at the main body, such that the tray is insertable into or ejectable from the main body through the entrance;
a loading unit to insert or eject the tray into or from the main body; and
a safety door, mounted at the entrance, to close the entrance after the tray is inserted into the main body, the safety door being opened and closed according to the operation of the loading unit.

11. The apparatus according to claim 10, wherein the tray comprises:
a disc location part formed at an upper surface thereof;
opposite ends, which are supported by guide rails to be mounted at opposite sides of the main body such that the tray may be inserted into or ejected from the main body in a sliding fashion by sliding along the guide rails; and
a first rack gear, which extends a predetermined length in the direction in which the tray is to be inserted or ejected from the main body, disposed at a lower surface of the tray.

12. The apparatus according to claim 10, further comprising a deck, mounted in the main body, comprising a spindle motor and an optical pickup unit, on which a disc is to be placed.

13. The apparatus according to claim 12, wherein the deck is shaped like a flat board and is moved upward and downward by the loading unit, and the spindle motor is mounted at an upper surface of the deck to rotate the disc.

14. The apparatus according to claim 12, wherein the loading unit comprises a motor operated pinion gear to engage with the first rack gear such that, when the pinion gear is rotated, the tray is inserted into or ejected from the main body.

15. The apparatus according to claim 14, wherein the loading unit further comprises:
a cam to raise and lower the deck; and
an actuating lever to open and close the safety door.

16. The apparatus according to claim 15, wherein the cam is mounted in the main body such that the cam moves in forward and backward directions that intersect a direction in which the tray is inserted or ejected.

17. The apparatus according to claim 16, further comprising a rail disposed at a bottom surface of the main body to support the cam.

18. The apparatus according to claim 17, further comprising a second rack gear, which engages with the pinion gear after the tray is inserted into the main body; disposed at one side of the cam.

19. The apparatus according to claim 18, wherein the cam comprises slots to move the deck upward and downward when the cam is moved forward and backward, and wherein protrusions, which protrude from the deck, are inserted into the slots.

20. The apparatus according to claim 19, wherein when the second rack gear engages with the pinion gear, the first rack gear disengages from the pinion gear.

21. The apparatus according to claim 15, wherein the actuating lever comprises:
a support shaft rotatably supported by coupling members at a bottom surface of the main body;
a first extension part extending from one end of the support shaft such that the first extension part is pushed and turned by the cam; and
a second extension part, extending from another end of the support shaft toward an inside surface of the safety door, to be coupled with the safety door during opening and closing operations of the safety door.

22. The apparatus according to claim 21, wherein the safety door comprises:
guide rails disposed at opposite sides of the rear surface of the door, which are coupled with guide grooves formed at a front surface of the main body, such that the safety door is moved upward and downward a predetermined distance to open and close the entrance of the main body; and
a coupling protrusion, which protrudes from the rear surface of the safety door, engaged in a coupling groove formed at the second extension part of the actuating lever.

23. The apparatus according to claim 22, wherein when the tray is completely inserted into the main body, the cam is moved so as to raise the deck, and the cam pushes the first extension part of the actuating lever to rotate the actuating lever to cause the second extension part to turn and push the safety door upward.
